(19) United States
(12) Patent Application Publication
(10) Pub. No.: US 2022/0093988 A1
(43) Pub. Date: Mar. 24, 2022

(54) Electrochemical device with improved thermal conductivity

(71) Applicant: STOREDOT LTD., Herzeliya (IL)

(72) Inventors: Daniel ARONOV, Netanya (IL); Doron Myersdorf, Herzeliya (IL); Nir DOLEY, Lehavim (IL); Assaf ZEHAVI, Haifa (IL); Tzemah KISLEV, Mazkeret-Bathy (IL); Dan Corfas, Kfar-Saba (IL)

(73) Assignee: STOREDOT LTD., Herzeliya (IL)

(21) Appl. No.: 17/454,617

(22) Filed: Nov. 11, 2021

Related U.S. Application Data
(63) Continuation-in-part of application No. 17/304,647, filed on Jun. 23, 2021.
(60) Provisional application No. 62/705,362, filed on Jun. 23, 2020.
(60) Provisional application No. 63/199,744, filed on Jan. 21, 2021.
(60) Provisional application No. 63/198,786, filed on Nov. 12, 2020.

(51) Int. Cl. H01M 10/6553; H01M 50/107; H01M 10/655

(52) U.S. Cl. CPC H01M 10/6553; H01M 10/655; H01M 50/107

(57) ABSTRACT

An electrochemical device that includes an electrochemical cell. The electrochemical cell includes a thermal conductive path that thermally couples one or more interior elements of the electrochemical cell to an external part of the electrochemical cell.

### BACKGROUND

Batteries tend to heat in various conditions. Due to the heating and the limited thermal conductivity of the battery—the internal parts of the battery may be warmer than the exterior of the battery.

FIG. 1 illustrates an exterior of a prior art battery 20 that includes a positive terminal 11, a case 12 and a negative terminal 13.

FIG. 2 illustrates a cross section of a prior art battery that includes a inner space 21 defined by the innermost layer of multiple co-centric radial layers that include anodes 23, separators 22 and cathodes 24. The hollow space may also be referred to as a core.

FIG. 3 illustrates a part of a prior art array 25 of cells that are fixed to their positioned by a fixture.

The heating may damage and/or degrade the battery and there is a need to dissipate the heat developed even in the internal parts of the battery.

### SUMMARY

There may be provided systems, methods, and computer readable medium as illustrated in the specification.

### BRIEF DESCRIPTION OF THE DRAWINGS

The embodiments of the disclosure will be understood and appreciated more fully from the following detailed description, taken in conjunction with the drawings in which:

FIGS. 1-2 illustrate examples of prior art cells;

FIG. 3 illustrates an example of an array of cells;

FIGS. 4-6 illustrate examples of cells;

FIGS. 7-9 illustrate examples of cells, one or more module pack/plates and one or more mechanical fixation elements;

FIG. 10 illustrate an examples of a part of a cells;

FIG. 11 illustrates an example of an array of prismatic cells;

FIGS. 12-13 illustrate examples of cells;

FIGS. 14-15 illustrate examples of parts of cells;

FIG. 16 illustrate examples of parts of a cell; and

FIG. 17 illustrates an example of a method.

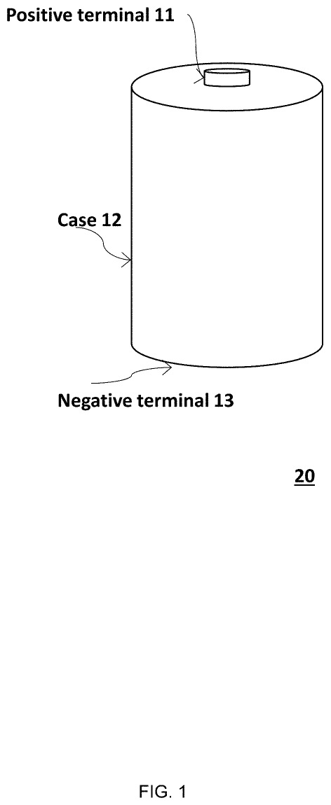

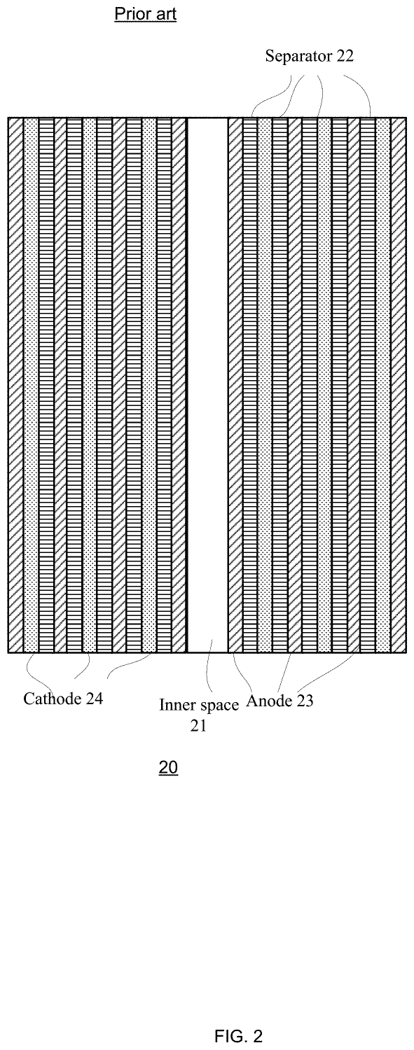

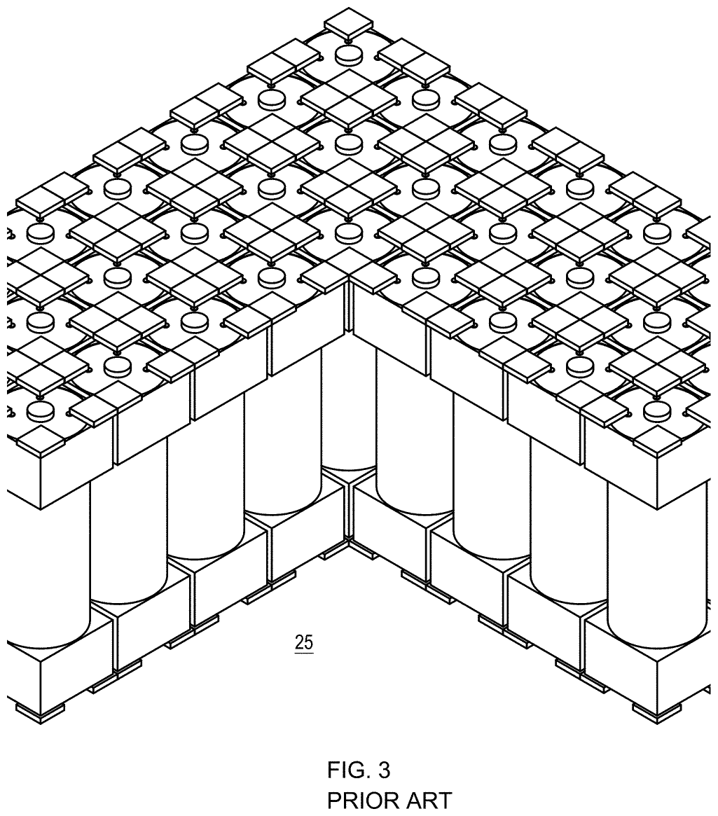

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method.

Any reference in the specification to a system or device should be applied mutatis mutandis to a method that may be executed by the system.

Any combination of any module or unit listed in any of the figures, any part of the specification and/or any claims may be provided.

Any combinations of systems, units, components, processors, sensors, illustrated in the specification and/or drawings may be provided.

There may be provided a method, and an electrochemical device that may include a thermal conductive path for cooling its interior.

An electrochemical device (“device”) may be an electrochemical cell (“cell”), may include one or more cells, may be an array of cells, may be or may include one or more electrochemical batteries (“batteries”), and may include one or more components in addition to any cell or battery.

The electrochemical device may be of any chemistries (i.e. supercapacitor, li-ion, sulphur, metal-based, etc).

The cell may be assembled in a manner that may include known steps—roll to roll, winding, jelly roll, etc as well as one of more additional steps such as forming the thermal conductive path, inserting elements such as one or more sensors with the thermal conductive path, and the like.

The cells may be of any size and shape—for example cylindrical, prismatic and the like.

The suggested device may exhibit
Improved thermal conductivity.
Improved thermal homogeneity inside the cell.
Facilitating thermal and safety management.
Improved cycle life, and shelf live.
Enhanced electrochemical performance (i.e. charge/discharge high current response, long duration continuous use).
Allowing monitoring and diagnostic tools, using integrating sensors.

The cell form factor can be changed in both, linear (length) and radial (diameter) directions.

Placement and/or structure of the positive and negative terminals can be changed and/or optimized for the desired cell form factor, including the bolted connection design.

The thermal conductive path may be used for a flow of air, liquid, semi-solid and/or solid (or any combination thereof) cooling approach.

All mentioned cooling solutions can be applied by active and/or passive approach.

The thermal conductive path and case may include different materials, and have different thermal conductivity properties.

Cell electrodes are winded (jelly rolled) around a hollow inner space. The sidewall of the inner space are defined by the innermost electrode. A thermal conductive path may be formed within the inner space—and may be made of thermal conductive material such as metal. The thermal conductive path may be exposed to the exterior of the cell and/or may be thermally coupled to a thermal conducting element that may be positioned between the thermal conductive path and the case or the exterior of case.

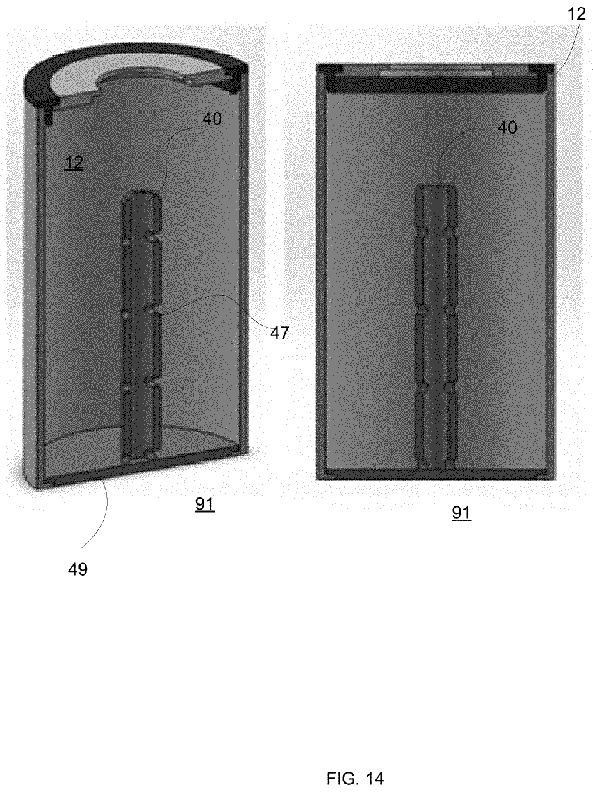

The thermal conductive path may include holes or openings or apertures (collectively referred to as opening) to enable electrode to flow from one opening to the other—and move within the cell—between different parts of the cell that do not belong to the thermal conductive path. Openings are denoted 47 in FIG. 14.

The thermal path may be of any size (length, thickness, width, and the like may be of any value), may be of any shape, and there may be any relationship between one or more dimensions of thermal conductive path and one or more dimensions of the cell. The length of the thermal conductive path may be optimized for the desired cell form factor and design.

The thermal path may be through path—that pass through the entire cell—and can be seen from both sides of the path.

There may be more than a single thermal conductive path per cell or per battery. If there are more than a single path—they may be equal to each other, differ from each other, may be parallel to each other or oriented to each other, may be spaced apart from each other or may cross and/or join each other.

The thermal conductive path may be of any size, shape and orientation in relation to the cell.

A dimension (for example, length, width, radius) of the thermal conductive path may be changed (between one cell to another) and/or optimized for the desired cell form factor and design.

A dimension (for example, length, width, radius) of the thermal conductive path may be variable over the length of the path—for example for at least partially compensate for the “thermal” distance or resistance between different interior locations and the case.

The cell may include sensors that may be positioned (for example in a non-blocking manner or a blocking manner)—within the thermal conductive path.

The thermal conductive path may be partially filled with thermal conducting elements that are smaller than the path that also allow fluid to pass through the gaps between the thermal conducting elements.

Sensors may sense pressure, temperature and the like and may provide an indication of heat, gas flow, stran, and etc generation.

One or more pressure sensor/s may be connected between or/and inside the fixation stand in order to measure the pressure inside the device and/or system in linear (length) and/or axial (radial) directions.

The thermal conductive path is applicable for any electrochemical devices and chemistries (i.e. supercapacitor, li-ion, sulphur, metal-based, etc).

Cell assembly process flow is in similar fashion to the standard one (i.e. roll to roll, winding, jelly roll, etc).

The thermal conductive path may be used for the cell fixation and integration to the module/pack structure, providing:
Easy fixation and assembly of the cells.
Improved thermal contact.
Improved electrical contact for positive and negative terminals.
The cell form factor can be changed in both, linear (length) and radial (diameter) directions.
Placement and/or structure of the positive and negative terminals can be changed and/or optimized for the desired cell form factor, including the bolted connection design.

The fixation stand may be assembled as a separated unit or connected (i.e. as a part of) to the any of the module or/and pack plates.

The fixation stand may include a single or multiple units from one or different materials.

The thermal conductive path may be used for air, liquid, semi-solid and/or solid (or any combination thereof) cooling approach in parallel (in conjugation with) to the fixation an/or assembly stands.

Temperature, pressure, optical and other relevant sensors (or any combination thereof) can be integrated within the thermal conductive path in parallel (in conjugation with) to the fixation an/or assembly stands.

The same approach can be also applicable for other, than cylindrical cell designs, such as prismatic, etc.

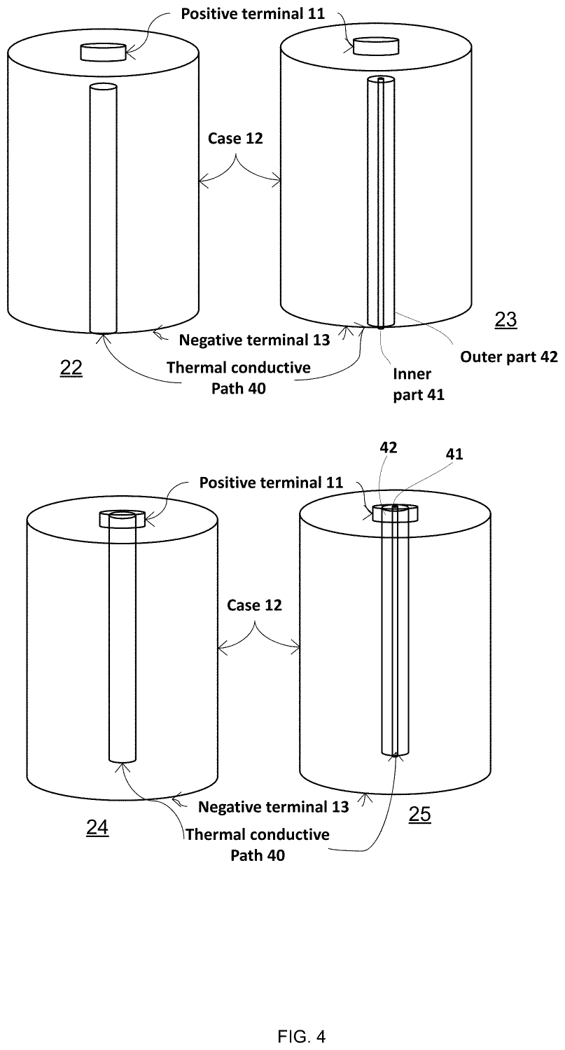

FIG. 4 illustrates examples of cylindrical cells 22, 23, 24 and 25—each includes a case 12, a positive terminal 11 (located at the top of the cell), a negative terminal 13 (located at the bottom of the cell), and a thermal conductive path 40 formed at the center of each cell—for example—at a location of the cylindrical inner space.

Cell 22 includes a thermal conductive path 40 that reaches the bottom of the cell does not reach the top of the cell and is cylindrical.

Cell 23 includes a thermal conductive path 40 that includes an inner part 41 and an outer part 42 that surrounds the inner part 41, whereas the thermal conductive path 40 does not reach the top of the cell and is cylindrical. The inner part may be connected in a non-blocking manner to the outer part. The top of the inner part may be lower than the top of the outer part to allow a flow of fluid between the top of the inner part to the top of the outer part.

Cell 24 includes a thermal conductive path 40 that passes through the top of the cell (through positive terminal 11) without reaching the bottom of the cell.

Cell 25 includes a thermal conductive path 40 that passes through the top of the cell (through positive terminal 11) without reaching the bottom of the cell. The thermal conductive path 40 includes an inner part 41 and an outer part 42 that surrounds the inner part 42.

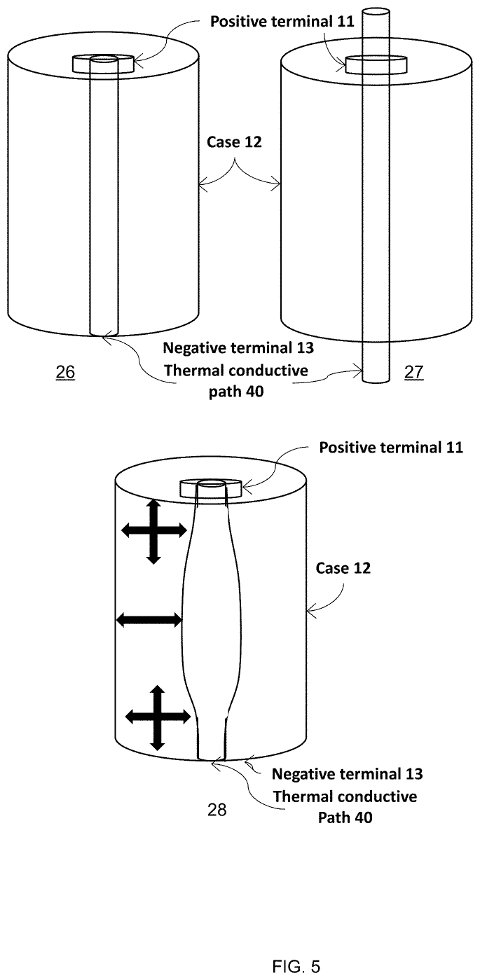

FIG. 5 illustrates examples of cylindrical cells 26, 27 and 28—each includes a case 12, a positive terminal 11 (located at the top of the cell), a negative terminal 13 (located at the bottom of the cell), and a thermal conductive path 40 formed at the center of each cell.

Cells 26 and 27 include a thermal conductive path 40 that passes through the entire cell—from top to bottom (even through positive terminal 11 and negative terminal). In cell 27, the thermal conductive path 40 also extends outside the cell.

Cell 28 illustrates a thermal conductive path 40 that has a cross section that changes along the longitudinal axis of the cell. In this example the cross section increases with a distance from boundaries (top and bottom) of the cell—till reaching a maximal value at the center (height wise) of the cell. The change in the cross section may be stepped, continuous, non-continuous, and the like.

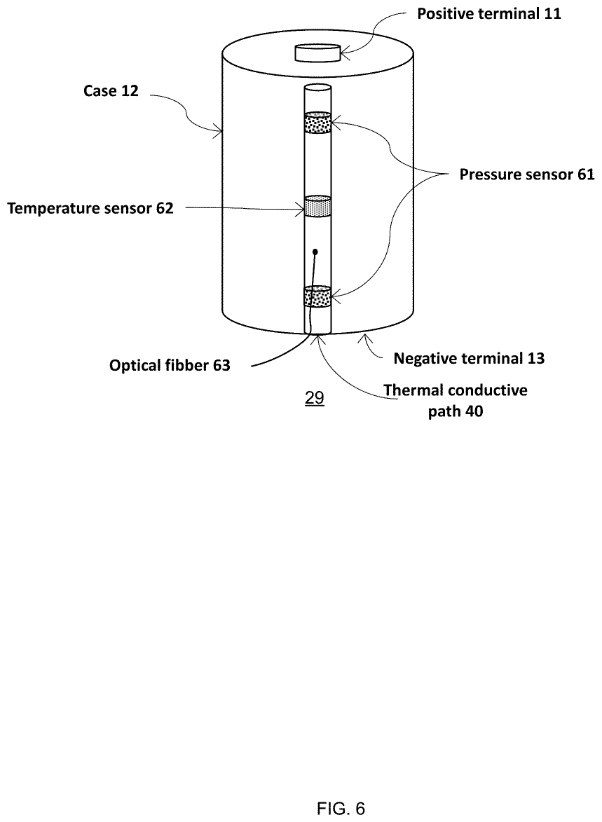

FIG. 6 illustrates an example of a cylindrical cells 29 that includes a case 12, a positive terminal 11 (located at the top of the cell), a negative terminal 13 (located at the bottom of the cell), and a thermal conductive path 40 formed at the center of each cell. A temperature sensor 62, two pressure sensors 61 and an end of optical fiber 63 are located within the thermal conductive path 40. Any sensor may be positioned in blocking manner or non-blocking manner. A blocking sensor blocks the passage of fluid from one side of the sensor to the opposite side of the sensor. There may be provided by number of sensors and/or any types of sensors within (or partially within) the thermal conductive path 40.

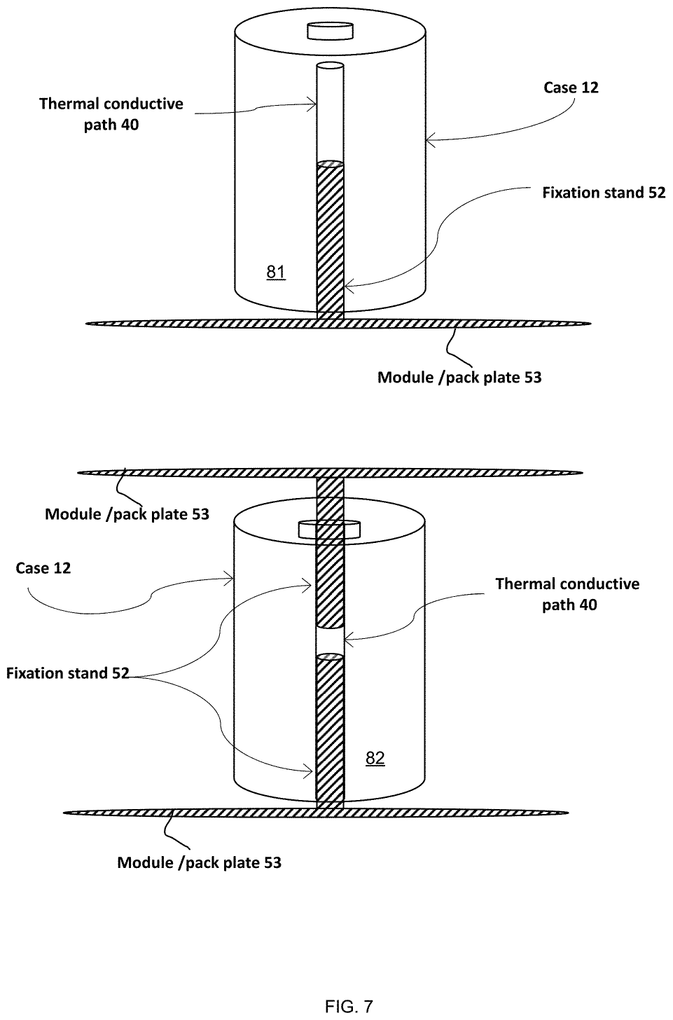

FIG. 7 illustrates examples of cylindrical cells 81 and 82—each includes a case 12, a positive terminal 11 (located at the top of the cell), a negative terminal 13 (located at the bottom of the cell), and a thermal conductive path 40 formed at the center of each cell. The cell may be fixed to a module pack/plate 53 by one or more mechanical fixation elements such as fixation stands 52 that are shaped and size to fit within the thermal conductive path 40.

Cell 81 is fixed to a module pack/plate 53 located below the cell using a fixation stand 52 that enters the bottom of the thermal conductive path 40.

Cell 82 is (a) fixed to a module pack/plate 53 located below the cell using a fixation stand 52 that enters the bottom of the thermal conductive path 40, and (b) fixed to a module pack/plate 53 located above the cell using another fixation stand 52 that enters the top of the thermal conductive path 40, through the positive terminal 11. There is a gap between the fixation stands 52.

Any fixation stand may have any thermal conductivity value.

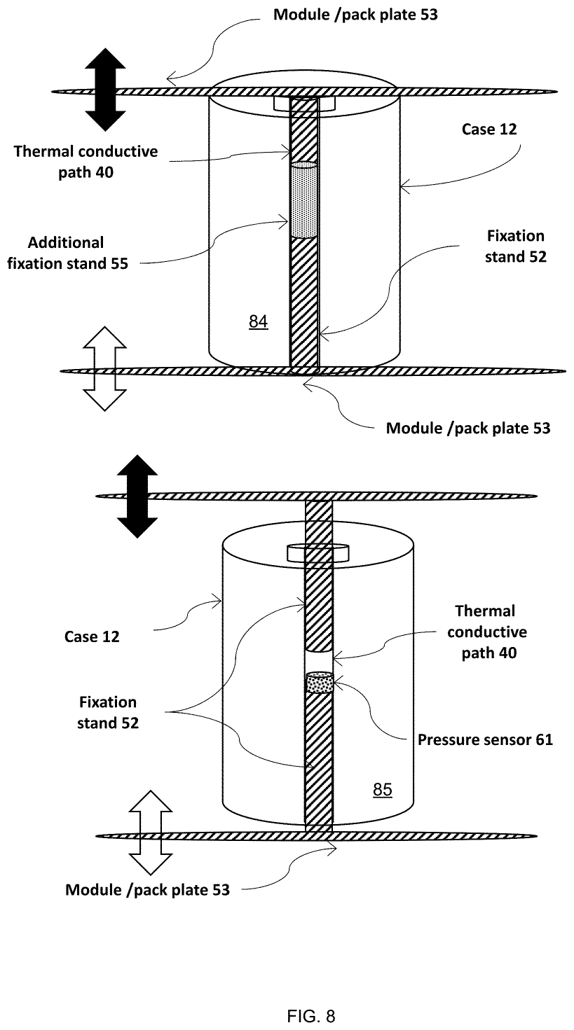

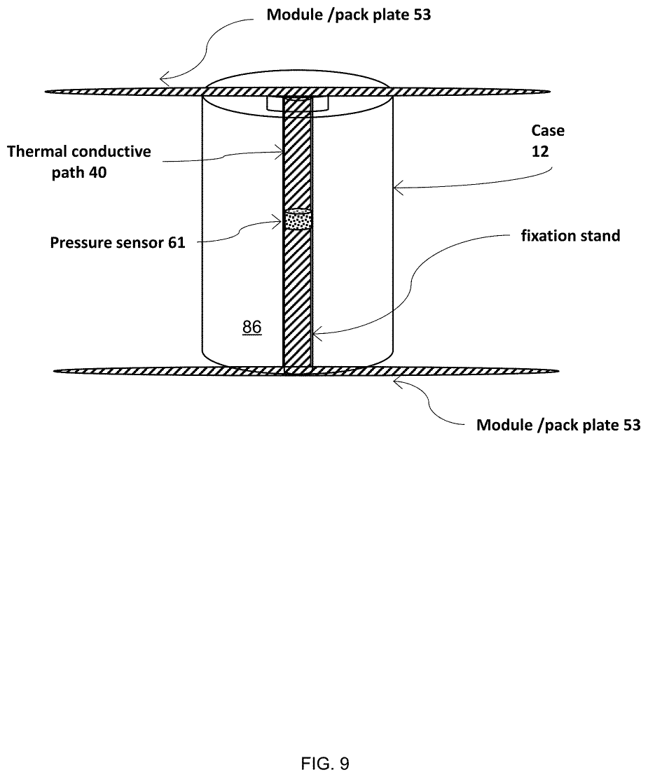

FIGS. 8 and 9 illustrate examples of cylindrical cells 84, 85 and 86—each includes a case 12, a positive terminal 11 (located at the top of the cell), a negative terminal 13 (located at the bottom of the cell), a thermal conductive path 40 formed at the center of each cell. In addition each cell is fixed to top and bottom module pack/plates 53 by top and bottom mechanical fixation elements such as top and bottom fixation stands 52 that are shaped and size to fit within the thermal conductive path 40.

In cell 84, another fixation stand 55 closes a gap between the top and bottom fixation stands 52.

In cell 85, a sensor such as a temperature sensor (thermal sensor) 62 is located within the gap between the top and bottom fixation stands 52—leaving a gap between the temperature sensor and one of the top and bottom fixation stands 52.

In cell 86, a sensor such as a temperature sensor 62 is located within the gap between the top and bottom fixation stands 52—without leaving a gap between the temperature sensor and any one of the top and bottom fixation stands 52.

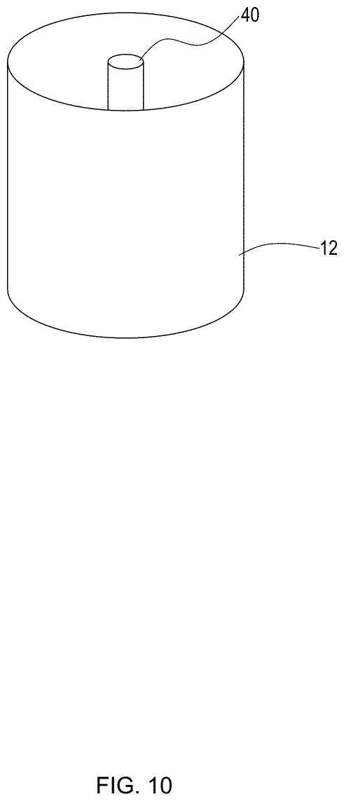

FIG. 10 is an example of a part of a case 12 of a cell and a thermal conductive path 40.

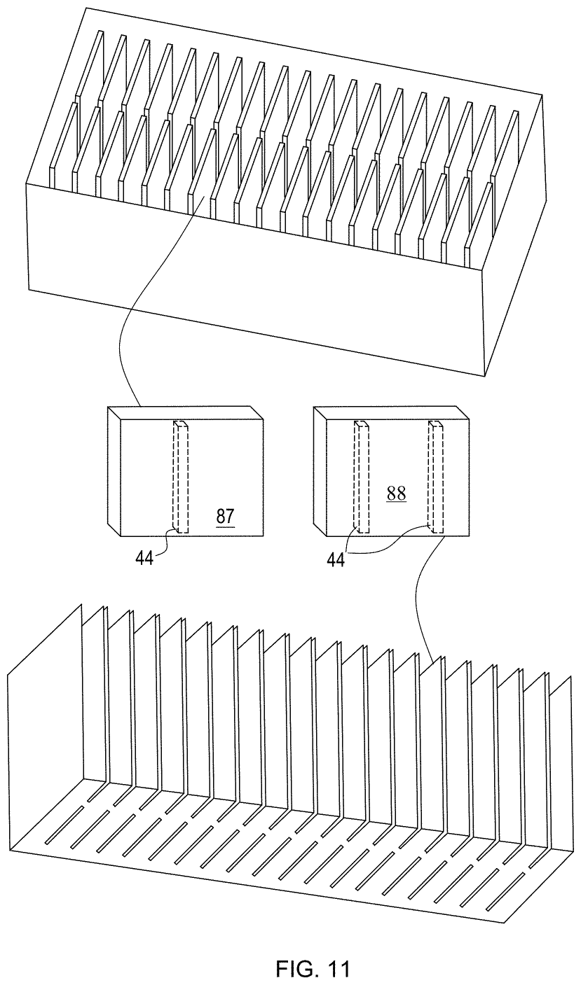

FIG. 11 is an example of an array of prismatic cells in which one or more (and even all) cells (for example—prismatic cell 87 and prismatic cell 88) include one or more thermal conductive paths 44. The array may include prismatic cells such as cell 87 and/or cells such as cell 88. Any thermal conductive path 40 and/or any sensors or any other elements illustrated above may be included in each prismatic cell. Any prismatic call may include any number of thermal conductive path 40—or any shape and size.

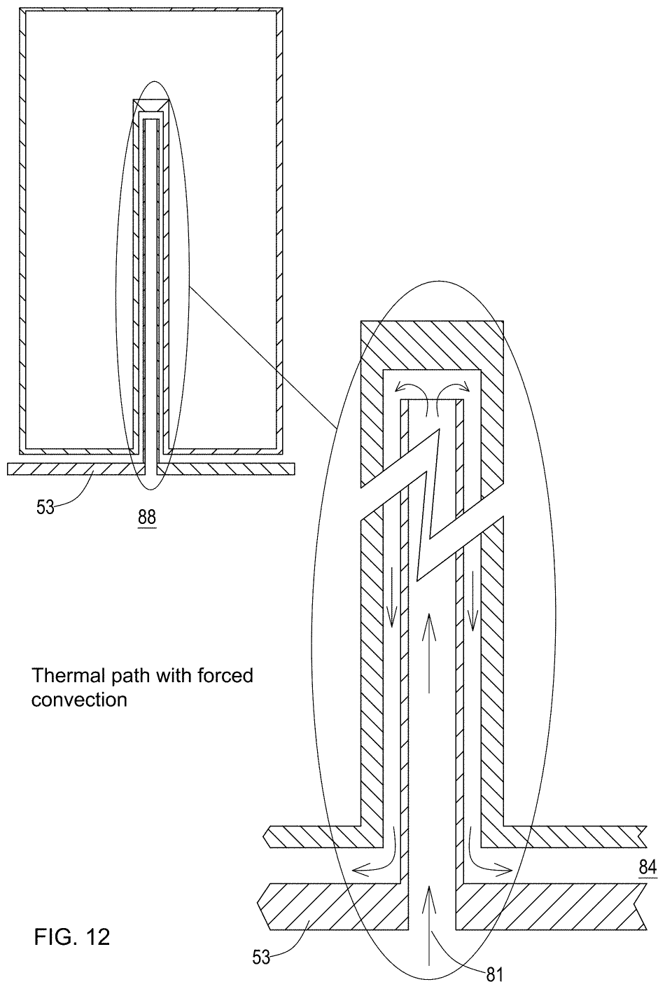

FIG. 12 is an example of an a cylindrical cell 88 that has a thermal conductive path 40 with an inner and outer parts 41 and 42, wherein a conduit 81 that is external to the cell is fluidly coupled to the inner part 41 and provides fluid to the inner part, the fluid passes through the inner part and then the outer part and exits through a gap 84 formed between a bottom of the cell the bottom module pack/plates 53.

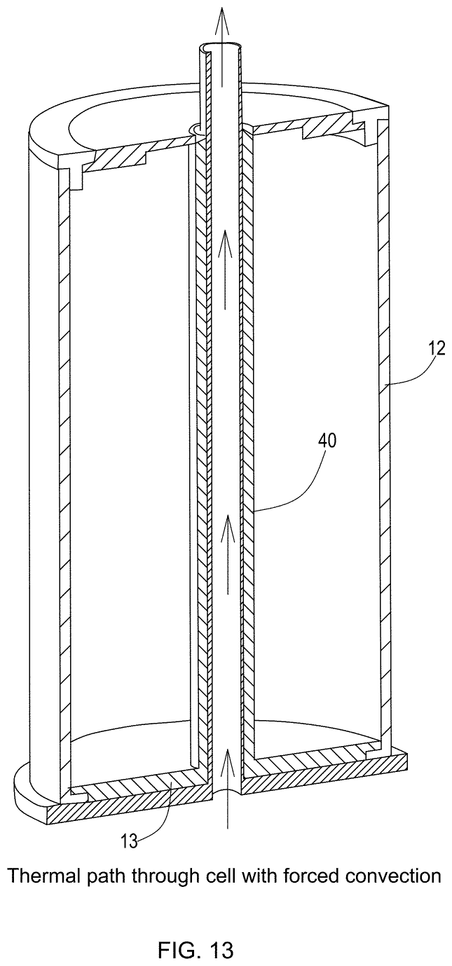

FIG. 13 is an example of a cylindrical cell 89 that has a thermal conductive path 40 that passes through the entire cell, wherein a conduit that is external to the cell is fluidly coupled to the thermal conductive path 40 and provides fluid to the thermal conductive path 40, the fluid passes through the thermal conductive path 40 and exits from the top of the thermal conductive path 40.

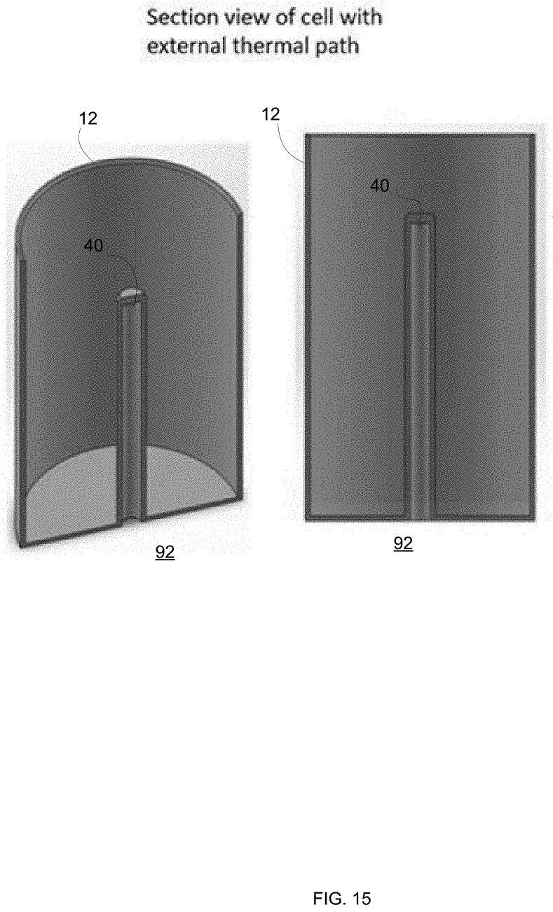

FIGS. 14 and 15 illustrate examples of cases 12 and thermal conductive paths 40 of cells 91 and 92. FIG. 14 illustrates openings 47 through which electrolyte may flow.

Cell 91 includes an internal thermal conductive path 40 that is internal—the cell does not have an opening that exposes the thermal conductive path 40. The thermal conductive path 40 is thermally coupled to a thermal conductive base 49—for better dissipation of heat to the case.

Cell 92 includes a thermal conductive path 40 that is exposed to the exterior of the cell.

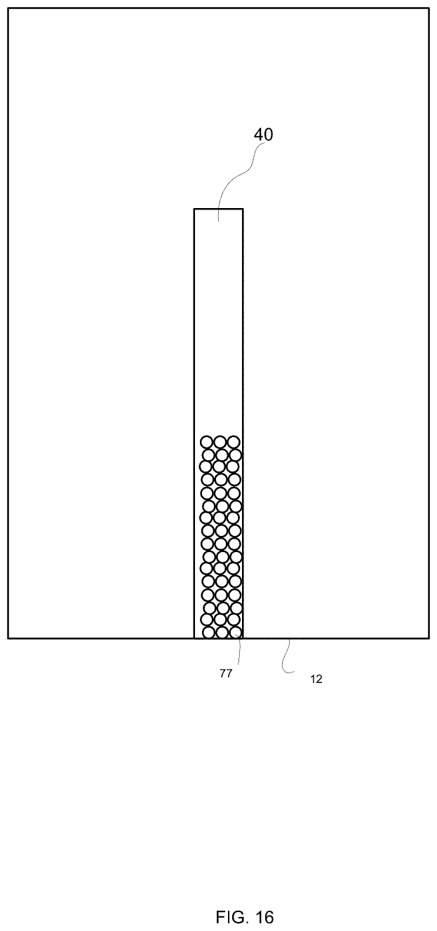

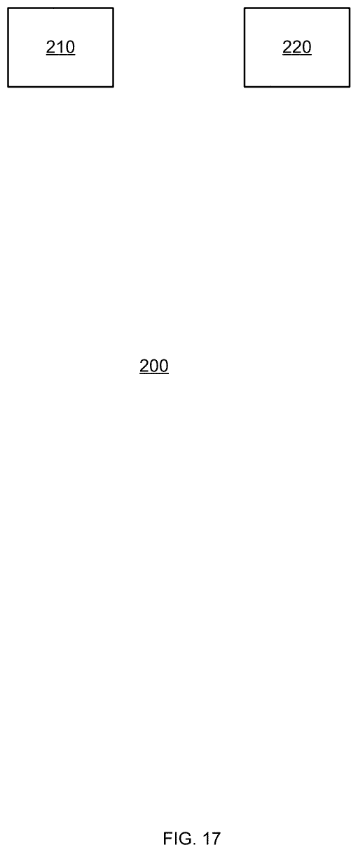

FIG. 16 illustrates thermal conductive elements 77 that partially fill a thermal conductive path 40 within a cell—thus allowing fluid to pass within the thermal conductive path. The thermal conductive elements 77 may be of any size and shape—they may be smooth, not smooth, and the like.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. An electrochemical device that comprises an electrochemical cell, wherein the electrochemical cell comprises a thermal conductive path that thermally couples one or more interior elements of the electrochemical cell to an external part of the electrochemical cell.

2. The electrochemical device according to claim 1 wherein the thermal conductive path is concealed by the case.

3. The electrochemical device according to claim 1 wherein the thermal conductive path extends through the case.

4. The electrochemical device according to claim 1 wherein the thermal conductive path passes through a terminal of the electrochemical cell.

5. The electrochemical device according to claim 1 wherein the thermal conductive path is segmented to thermal conductive path segments.

6. The electrochemical device according to claim 5 wherein one of the thermal conductive path segments surrounds another one of the thermal path segments.

7. The electrochemical device according to claim 5 wherein one of the thermal conductive path segments is parallel to another one of the thermal path segments.

8. The electrochemical device according to claim 1 wherein a cross section of the thermal path segment is unchanged along a longitudinal axis of the thermal conductive path segments.

9. The electrochemical device according to claim 1 wherein a cross section of the thermal conductive path segment changes along a longitudinal axis of the thermal conductive path.

10. The electrochemical device according to claim 1 wherein a cross section of the thermal conductive path is shaped and sized based upon values of thermal conductivity of different points of the thermal conductive path.

11. The electrochemical device according to claim 1 further comprising at least one sensor that is positioned within the thermal conductive path.

12. The electrochemical device according to claim 11 wherein the at least one sensor comprises a pressure sensor.

13. The electrochemical device according to claim 11 wherein the at least one sensor comprises a temperature sensor.

14. The electrochemical device according to claim 11 wherein the at least one sensor comprises a temperature sensor.

15. The electrochemical device according to claim 1 wherein the thermal conductive path is hollow.

16. The electrochemical device according to claim 1 wherein the electrochemical cell comprises at least one additional thermal conductive path.

17. The electrochemical device according to claim 1 further comprising one or more mechanical fixation elements for fixing a position of the electromechanical cell within the electrochemical device.

18. The electrochemical device according to claim 17, wherein the one or more mechanical fixation elements are shaped and sized to interface with at least a part of an interior of the thermal conductive path.

19. The electrochemical device according to claim 18 wherein the one or more mechanical fixation elements are positioned, at least in part, within the thermal conductive path.

20. The electrochemical device according to claim 17, wherein the electrochemical device is a battery.

21. The electrochemical device according to claim 1 comprising the electrochemical cell and one or more additional electrochemical cells to provide multiple electrochemical cells, wherein at least some of the multiple electrochemical cells comprise the thermal conductive path that thermally couples one or more interior elements of the electrochemical cell to the external part of the electrochemical cell.

22. The electrochemical device according to claim 1 comprising the electrochemical cell and one or more additional electrochemical cells to provide multiple electrochemical cells, wherein each of the multiple electrochemical cells comprises the thermal conductive path that thermally couples one or more interior elements of the electrochemical cell to the external part of the electrochemical cell.

23. The electrochemical device according to claim 1 comprising the electrochemical cell and one or more additional electrochemical cells to provide multiple electrochemical cells, wherein at least some of the multiple electrochemical cell comprises the thermal conductive path that thermally couples one or more interior elements of the electrochemical cell to the external part of the electrochemical device.

24. The electrochemical device according to claim 1 wherein the thermal conductive path is partially hollow.

25. The electrochemical device according to claim 1 wherein the thermal conductive path defines a fluid path.

26. A method for operating an electrochemical device, the method comprises: causing an interior of an electrochemical cell of the electrochemical device to heat; and dissipating at least a part of the heat using a thermal conductive path of the electrochemical cell; wherein the electrochemical cell comprises a thermal conductive path that thermally couples one or more interior elements of the electrochemical cell to an external part of the electrochemical cell.
